(19) United States
(12) Patent Application Publication
(10) Pub. No.: US 2022/0202040 A1
(43) Pub. Date: Jun. 30, 2022

(54) MULTICHANNEL FLOW CONTROL AND EXTRUDATE COOLING

(71) Applicant: The Livekindly Company Switzerland GmbH, Pfaffikon (CH)

(72) Inventor: Achim Knoch, Minden (DE)

(21) Appl. No.: 17/531,639

(22) Filed: Nov. 19, 2021

Related U.S. Application Data
(60) Provisional application No. 63/133,034, filed on Dec. 31, 2020.
(60) Provisional application No. 63/277,498, filed on Nov. 9, 2021.
(60) Provisional application No. 63/175,904, filed on Apr. 16, 2021.

(51) Int. Cl. A23J 3/26; A23P 30/20; A23J 3/14; A23J 3/22

(52) U.S. Cl. CPC A23J 3/26; A23J 3/227; A23J 3/14; A23P 30/20

(57) ABSTRACT

Systems and methods are disclosed herein for a multichannel cooling die. Some embodiments present a multichannel cooling die system comprising a cooling die with an inlet for entry of an extrudate into the cooling die and an outlet for exit of the extrudate from the cooling die, a cooling core that spans the length of the cooling die between the inlet and the outlet; a flow channel that facilitates the movement of an extrudate mixture from the inlet to the outlet, an outer jacket that spans the length of the cooling die, connected between the inlet and outlet, and circumferentially surrounding the flow channel forming an outer layer of the cooling die, and one or more dividers placed in the flow channel, extending through the flow channel for a first designated length and separating the flow channel into two or more separate flow channels.

### CROSS-REFERENCES TO RELATED APPLICATIONS

The present application claims the priority benefit of U.S. Provisional Application No. 63/133,034, titled “Multichannel Extrudate Cooling System”, filed Dec. 31, 2020. This application also claims the priority benefit of U.S. Provisional Application No. 63/277,498, titled “Dosing and Mixing Interim Plate”, filed Nov. 9, 2021. This application claims the priority benefit of U.S. Provisional Application No. 63/175,904 titled “Adjustable Cooling Die End Portion Plates”, filed Apr. 16, 2021. These applications are all hereby incorporated by reference in their entirety.

The present application is related to U.S. Nonprovisional application Ser. No. 17/493,723 titled “Changeable Rotatable Cooling Die Outlet End Plates”, filed Oct. 4, 2021, which is hereby incorporated by reference in its entirety.

### FIELD OF INVENTION

The present technology pertains to cooling systems and methods for food extrudates, mixtures and compositions and the improvement of cooling systems by increasing their efficiency and improving the quality of products they produce. In particular, but not by way of limitation, the present technology provides multichannel extrudate cooling systems and methods.

### SUMMARY

In some embodiments the present technology is directed to a multichannel cooling die system, the system comprising a cooling die with an inlet for entry of an extrudate into the cooling die and an outlet for exit of the extrudate from the cooling die, the portion between the inlet and outlet comprising a length of the cooling die; a cooling core that spans the length of the cooling die between the inlet and the outlet; a flow channel that facilitates the movement of an extrudate mixture from the inlet to the outlet, spanning the length of the cooling die, adjoining and surrounding the circumference of the cooling core; an outer jacket that spans the length of the cooling die, connected between the inlet and outlet, and circumferentially surrounding the flow channel forming an outer layer of the cooling die, the space between the inner side of the outer jacket and a base of the flow channel forming the height of the flow channel; one or more dividers placed in the flow channel, extending through the flow channel for a first designated length and separating the flow channel into two or more separate flow channels, wherein the one or more dividers are sealably connected to the base of the flow channel.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1. presents an exemplary embodiment of the inner portion of the multichannel cooling system without the surrounding jacket.

FIG. 2 is a diagrammatical representation of the frontal view of the exterior of the outlet end of one embodiment of the multichannel cooling system.

FIG. 3. presents a diagrammatical top-side view representation of one embodiment of an annular cooling die.

FIG. 4. is a cross-sectional top view of a longitudinal section of one embodiment of the cooling system, that illustrates the different parts of the cooling die present in the system.

FIG. 5 shows a diagrammatical representation of the inner part of a multichannel cooling die system with full length divider inserts.

FIG. 6 is a diagrammatical representation of a multichannel cooling die (without showing the outer jacket) with extended divider inserts.

FIG. 7 presents a diagrammatical representation of a multichannel cooling die (without showing the outer jacket) and with shortened divider inserts. embodiment of a multichannel cooling system extending through a portion of a cooling die.

FIG. 8 presents a diagrammatical representation of one embodiment of a multi-channel cooling system (without showing the outer jacket) extending into a transitionary apparatus and a portion of the cooling die.

FIG. 9 presents a diagrammatical representation of an accelerated multichannel cooling die (without showing the outer jacket) with partially widened divider inserts.

FIG. 10 presents a diagrammatical representation of an accelerated flow multichannel cooling die system (without showing the outer jacket) with partially widened divider inserts.

FIG. 11. is a diagrammatical representation of a high moisture extrudate (HME) extrusion process.

FIG. 12. is a diagrammatical representation of a laminar flow profile created in an extrudate cooled in a flat cooling die.

FIG. 13 shows a comparison of three extrudate mixture products with different laminar flow profiles.

### DETAILED DESCRIPTION

Meat analogues and meat alternative products made from plant proteins, plant products, protein concentrates and isolates are gaining in popularity, this is due to a variety of factors including increased environmental consciousness; specifically, the effects the meat industry is known to have on climate change, global warming and the high level of greenhouse gases it produces, and increased health consciousness in the general population with the promotion of low cholesterol, low fat, plant-based protein alternatives as well as increased awareness of animal rights in the developed world.

However, in their current state, meat analogues, meat alternatives and plant-based foods and proteins may suffer from several disadvantages and shortcomings relative to natural meat. Some obvious disadvantages and shortcomings of current alternative meat products are their taste and texture, which are different from and fail to replicate the taste and texture of natural meats. Plant-based alternatives also fail to resemble meats in color, shape, smell and other physical characteristics. Finally, increasing the affordability and availability of these meat analogues and plant proteins are a challenge because producing plant-based meat alternatives are much costlier and more difficult than industrial scale meat production.

Therefore, in the field of meat analogue or meat alternative manufacturing processes, it is generally accepted that there are several goals that the final meat analogue product and the manufacturing process itself must meet; these include alternative meat products that are desirable to the senses, taste good and be affordable. Further, the alternative meat products should replicate the texture of natural meats. A meat-like texture allows the bite or crunch of a meat analogue product to feel like that of natural meats to the consumer. Other goals are for the meat analogue to have the same color and/or physically resemble natural meats. Processes making meat analogue products must be scalable, highly efficient, and largely free from manufacturing defects and disruptions. Production line efficiency allows the meat analogue to be affordable and widely available to the general population as a reasonable and realistic alternative to animal proteins.

To realize these goals, the meat analogue industry has moved towards a High Moisture Extrusion (HME) process (referred to herein as “extrusion”, “extrusion process”, “HME process” or “HME”). It is generally accepted that the HME process involves several standardized steps, these steps may be modifiable, altered, added to, or removed depending on the mixtures, recipes and ingredients used as well as the desired product outcome. However, the standard process includes feeding and conveying ingredients into an extruder, mixing, heating and melting these ingredients in the extruder, feeding the mixture into a cooling die which further cools and structures the mixture to achieve and/or maintain the desired meat-like texture and excrete it as a final or semi-finished product (referred to herein as “texturate” or “extrudate”). Post-processing steps may also be added after the HME process, after the cooling die, to the texturate/extrudate, which may include cutting and shearing the protein, or more typically after the extrudate leaves the cooling die, these steps may include cutting, shearing, cooking, freezing, storing, or adding flavors, fats and other food manufacturing and culinary additives. The adding of flavors to the extrudate is usually done before the extrudate is frozen to be packaged.

The extrudate mixture that is fed into and/or is created in the extruder may be comprised of any food manufacturing ingredient including and not limited to plant proteins, soy or pea proteins or isolates, plant protein concentrates, protein isolates, meat proteins and compositions, animal milk proteins and protein products and concentrates, as well as additives such as flavor enhancers, preservatives, PH agents, color additives, fats, bonding agents and compositions, salts as well water, other solutions and liquids. The extrudate mixture may be pre-mixed before feeding into the extruder, alternatively, separate components may be added individually into the extruder, or a combination of both.

The texture of the extrudate mixture ideally should have long meat-like fibers in parallel that are placed on top of each other. One way to achieve a meat-like texture is by having a laminar flow of the extrudate mixture in the cooling die, whereby the flow of the mixture is such that a pattern resembling a half moon shape is created. This pattern is a similar pattern to what is found in natural meats. In most current embodiments, a thickness of 10-11 mm of meat-like protein is produced, but a thickness of 20-25 mm is an ideal thickness which resembles that of natural meats like a steak or a chicken breast.

As discussed above, to cool the extrudate mixture and create and/or maintain the meat-like texture of the extrudate mixture, the mixture must be cooled immediately after leaving the extruder, preferably from its temperature of approximately 100-155° Celsius (212-311° F.) to approximately 70-95° Celsius (158-203° F.) by a cooling system such as a cooling die. Other ranges of temperatures and combinations may be used in the standard process described above to achieve varying product outcomes. The extrudate mixture must therefore quickly be inserted or fed into the cooling system or cooling die after exiting the extruder's outlet.

Typically, the cooling systems that are utilized in the cooling die step after extrusion are either flat cooling dies or round/annular cooling dies, also known sometimes as cooling nozzles among various other names. Both these types of cooling dies are well known to those skilled in the art. Each type has its advantages and disadvantages. A flat cooling die has the advantage that it creates a laminar flow in the extrudate material, which resembles that of natural animal meat, however it is limited to low throughputs, and must be widened if attached to a high throughput extruder but must contend with a loss in pressure with the extra width of the die, which makes it more difficult to homogenously convey the extrudate from the extruder into the cooling die. Furthermore, the laminar flow profile of the extrudate becomes increasingly flat when increasing width of a flat cooling die.

To allow a higher throughput yet at the same time maintain an even pressure while cooling the extrudate mixture, the industry has begun utilizing annular or round cooling dies which are able to maintain the integrity and texture of the extrudate mixture at higher throughputs and rates of flow. When referring to a round cooling die in this document, this refers to a die with a round gap (a flow channel that is annular in shape and surrounds a cooling core), the cooling core cools the hot melted mixture that comes out of the extruder and moved through the surrounding flow channel. Round cooling dies in this document do not refer to a roundish shape die, resembling a hollow pipe, where the hot melted mixture out of the extruder is flowing through the hollow cooled pipe. The round cooling dies generally have a cylindrical cooling core running across a longitudinal plane, which is surrounded by the extrudate mixture flowing through the die on all sides through one flow channel. This allows the material to flow through at an even rate, and be cooled uniformly from all directions, while providing increased throughput and flow rates relative to the flat dies. Another benefit of a round cooling die relative to a flat/wide cooling die, is that the conveying of extrudate material from the extruder to the cooling die is much easier with a round cooling die.

These round cooling dies however are not able to produce the desired laminar flow pattern in the extrudate material to provide the same fiber pattern as natural meat products as is readily produced by flat cooling dies. Also, while the increased surface area and cooling surface of a round cooling die allows an increase in throughput, it is still subject to typical cooling die limitations; where if the throughput goes up significantly without controlling the rate of flow, then the cooling process inside the cooling die affects the quality of the final product, since an uncontrolled flow rate means that the relationship between heat transfer and the flow field is increasingly irregular, creating unfavorable conditions for consistent cooling, causing the product to lose its texture. Round cooling dies with a roundish gap are generally well known in the art and will not be described in detail.

The multichannel flow control and cooling system (“the cooling system”) proposed in this document incorporates the benefits of the flat cooling dies within the basic structure of a round cooling die system. This allows a higher throughput rate relative to both systems, as well as producing multiple laminar flows of extrudate material in multiple channels. It does this by having multiple and separate adjacent flow channels surrounding a cooling core. In each flow channel there will a laminar flow profile, but each channel will be adjoined to, and surrounds a portion of the inner cooling core, as the flow channel and the extrudate mixture it carries runs along the cooling core longitudinally. This allows the round cooling die to have multiple flow channels each with the same conditions, throughput, temperatures and pressure. This means that this cooling system will have the advantages of a flat, small die, working in low throughput range (which leads to a very high product texture quality) with the efficiency and total throughput capacity of a larger round cooling die, since the smaller flow channels are all working in parallel to produce a larger total output.

In various embodiments, the proposed multichannel cooling system has an inlet side and outlet side, and in some embodiments, it may be attached directly to the extruder from its inlet side, or it may be attached to a transitionary apparatus, such as an interim plate, placed between the cooling die and the extruder. The transitionary apparatus may also be part of the extruder or part of the cooling system or separate from both. In some embodiments the transitionary apparatus may be an interim plate, either automated or comprised of manually moving parts. The transitionary apparatus may also be utilized to facilitate the flow and/or movement of extrudate material from the extruder to the cooling die. The transitionary apparatus may also comprise an interim plate which may in some embodiments be a cone with one or more channels that are not fully separated. This specifically designed interim plate, may be static without powered, moving parts.

In some embodiments the cooling system is in an annular shape and comprises an outer jacket tubing, an inner jacket tubing separated by a cooling chamber or channel (these together form “the jacket”). The cooling channel may carry cooling agents and/or fluids and may contain inlets and outlets which allow the ingress and egress of cooling agents and/or fluids, and/or their circulation into and out of the cooling channel. Adjoining the side of the inner jacket tubing is a flow channel (one of a plurality of flow channels), where the extrudate mixture is fed into and flows through and cooled as it passes along the inner cooling core, the flow channel is adjoined, at its base, on the side opposite the inner jacket tubing by the inner cooling core, which extends along on the longitudinal axis with the flow channel. The cooling core may be of different sizes and lengths and may or may not extend all the way along the longitudinal axis with the full length of the flow channel. Adjacent to the flow channel is another flow channel, each flow channel may be separated by the adjacent flow channel by a separation mechanism including but not limited to a divider, a rod, an insert, or barrier (collectively referred to herein as “separation mechanism” or “divider insert”. These flow channels are placed next to one another surrounding the inner cooling core. The inner cooling core may in some embodiments carry cooling agents and/or fluids and may also contain inlets and outlets which allow the ingress and egress of cooling agents and/or fluids and/or their circulation into and out of the cooling channel.

The plurality of flow channels may also be surrounded by the inner jacket tubing on all sides which in turn may be surrounded by the cooling channel and then the outer jacket. In some embodiments the jacket may open and close in different sections or parts of the system, or along different points in the longitudinal axis. The jacket may be sealed by a variety of methods including by screws, inserts, seals, threads, and other methods known to those skilled in the art. In some embodiments, the jacket is of a simpler design without a cooling channel of its own. The flow channels, the cooling core, and the cooling channels described may be of any shape or size, including rectangular, cylindrical, oval, or angular shapes.

In some embodiments, the flow channels surrounding the inner cooling core are separated by dividers or rod inserts. In some embodiments these dividers may be sealably inserted and/or placed to separate the flow of the extrudate mixture into the different flow channels. The dividers are placed in different points around the flow channel surrounding the inner core, running longitudinally across the axis along with the flow channel, typically to the outlet side of the cooling system. In various embodiments, the dividers divide the flow channel into different widths but do not affect the length at which the flow channel runs.

In some embodiments each divider insert is made up of separate pieces that are modular and may be configured to different lengths or be connected or removed at different sections along the extrudate flow path in the flow channel. By way of example but not limitation, the portion closest to the inlet, i.e., the inlet side of the cooling system (where the extrudate mixture is fed into the system from an extruder or other device and/or method) may be divided into 8 channels, however as the extrudate mixture moves along the flow channel, 4 out of the 8 dividers are removed or are of shorter length, effectively disappearing and allowing immediately neighboring flow channels to join into 4 flow streams. This kind of customization allows more precise control of the stream as it goes through a cooling system or cooling die.

In various embodiments these divider inserts may be of varying lengths and placed in the cooling die in different arrangements to produce different numbers, lengths and types of flow channels. Some flow channels may begin at the inlet as separate channels, but due to the placement of a shorter divider insert, the flow channel may join with other flow channels, when the extrudate flows past the length of the shorter divider insert, combining the flow channel with one or more other channels.

In some embodiments, the multichannel cooling system also includes grooves or divider insert installation points pre-installed across different sections in the same flow channel(s) and/or the inner core and/or in the part of the inner jacket tube adjoining the flow channel(s). These grooves or installation points provide different placement options for each rod, divider, barrier or insert to be placed to allow customization based on the desired width of each channel, the number of channels and the width of each insert or divider.

In various embodiments the diameter of the inner cooling core may be increased relative to cooling dies and cooling systems available today, increasing the total cooling surface area available for the extrudate materials flowing through, this allows the installation of additional dividers and/or rod inserts and increasing the number of cooling channels available. This of course would allow the use of extruders with even higher throughput and power, without negatively affecting the flow rates in the cooling system since the additional throughput and pressure is divided amongst a larger number of channels, so that each channel maintains the same total individual throughput and flow field. In some embodiments, both the diameter of the inner cooling core as well as the diameter of the whole cooling die increase, allowing for larger surface area for extrudate to flow through as well as higher and wider cooling channels allowing more extrudate. This increase in size may also include an increase in length so that the extrudate material go through a longer cooling channel. This may be particularly useful when larger quantities of extrudate are able to flow through the cooling die.

One embodiment of the cooling system builds directly on annular or round cooling dies produced by companies, some examples may include General Mills, DIL or Buhler cooling dies. The general structure of these dies is generally the same; each one has an inlet end and outlet end, the inlet end either connected to an extruder or a transitionary apparatus or interim plate, and it is the end where the extrudate material is fed. The outlet is where the extrudate material exits the cooling die. These dies generally have a cooling core, typically of a rounded or cylindrical shape, and surrounded by the flow channel that carries the extrudate material. The flow channel carrying the extrudate material is then in turn surrounded by a cooling jacket. The jacket may have cooling tubes which cool the extrudate mixture from the outer side of the flow channel. The cooling system and methods described here place customized and modifiable dividers or inserts into the channel at different parts around the cooling core. These dividers separate the one channel into several individual channels, each having its own pressurized environment and/or flow rates.

In other embodiments, the proposed cooling system may use currently existing cooling dies and systems and improve these systems and devices by adding different pre-installed placement points, and/or divider inserts, or both in the flow channel(s) of each cooling system. These dividers may be modular or fashioned out of one piece, and different installation points and combinations can be used to control the width and length of each flow channel formed by the divider insert(s). Depending on the desired pressure, throughput and outcome, the flow channels may have different widths than others. This allows the system to have some flow channels with pressures varying from the pressures in other flow channels as part of the same cooling die system.

In all embodiments, the divider inserts may be made of any material, including but not limited to metallic alloys, plastics, or ceramics. In some embodiments, the divider inserts are made from heatproof or heat resistant materials or alloys. In some embodiments the divider inserts are cooled themselves, or include a coolant flowing through them, the coolant may either be stationary inside the plate, or be connected to coolant inlets and outlets that allow the coolants to circulate between the divider inserts, or for each divider insert individually. In some embodiments, the coolant in the cooling core may be circulated and connected to the divider insert coolant channels, allowing the circulation of coolant fluid between the cooling core and the divider inserts. In some embodiments, the divider inserts may also be connected to the coolant channels in the jacket tubes, allowing circulation of coolant fluids between them.

The cooled divider inserts, or the heat resistance of the material or metal alloy used for the divider inserts provides a cooler surface which points of the extrudate come into contact with the divider inserts becoming cooled at the points of contacts, mainly the edges, and forming a laminar flow profile shape in the extrudate. The dividers may also be made of different thicknesses and/or widths allowing varying widths for each channel. These dividers may in some embodiments be slidably inserted or removed, and in some embodiments may have to be installed into coupling interfaces that have to be first placed in or installed inside the channel. The dividers may be of any shape including, round, rectangular or angular shapes.

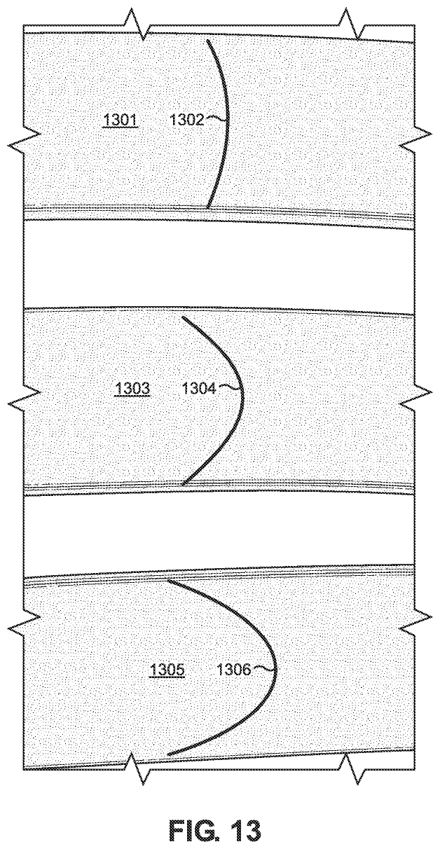

In various embodiments, hollow divider inserts are placed along the core of the cooling die, where the dividers include an internal cooling system to cool the extrudate that passes alongside them. In many of these embodiments the cooling occurs inside the divider(s) which are connected to the cooling system(s) of the cooling die; these cooling systems may include cooling systems of the inner jacket, outer jacket and/or the cooling core. These cooling systems may include cooling fluids or other cooling agents. Some embodiments include completely hollow dividers, while in others they may be filled with cooling or other agents. In many embodiments the dividers are solid and do not contain any cooling agents nor are they connected to other cooling systems. This would completely mimic the effects produced by a small flat die. This concept would lead to the effect, that the hot protein dough becomes firm at the edges of the divider insert with a perfectly shaped laminar flow profile (for example laminar flow pattern 1306 in FIG. 13).

In some embodiments, grooves or coupling interfaces for holding the divider inserts in place or sealably fixing them in position may have to be installed in existing cooling dies, inside a flow channel, on the inner side, outer side of a flow channel, on both sides of the flow channel, or installed in one or more of any of these positions. These grooves or coupling interfaces may be placed at different distances throughout the length of the cooling die, or alternatively, in other embodiments there may be only one coupling interface or divider insert holder placed in points along the circumference around the inner cooling core, these may be placed at the base of the flow channel adjoining the cooling core or opposite the base at the inner side of the jacket.

In some embodiments the inserts or dividers themselves may be shaped in a specific manner to be sealably inserted into a pre-existing cooling die via a sealable coupling interface, such as a silicon attachment piece. These dividers may be made from metallic alloys, plastics, ceramic,-or other suitable materials and shaped as rods or as flat rectangular pieces that have heat stable sealing materials such as silicon surrounding each end. As each rod or rectangular flat sheet is inserted into the channel where the extrudate mixture goes into the silicon on each side of the rod which create a malleable sealing interface with each side of the channel, coupling sealably with the outer jacket side of the channel and coupling sealably with the inner side of the channel adjoining the inner core. These dividers may be placed at different widths and be made up of separate pieces that connect separately across the longitudinal axis of the inner core. This allows the cooling die to be opened at different points for cleaning or other modifications.

By increasing the number of channels that surround the inner cooling core, the disclosed system may be able to produce throughputs of 1000 kg/hour or more based on a 12 mm cooling die. Furthermore, by increasing the diameter of the inner core as well as the outer jacket of the cooling die, and the number of flow channels surrounding the core, the disclosed system should comfortably reach 2000 kg/hour.

In some embodiments the height of each flow channel may also be increased to up to 25-30 mm.

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

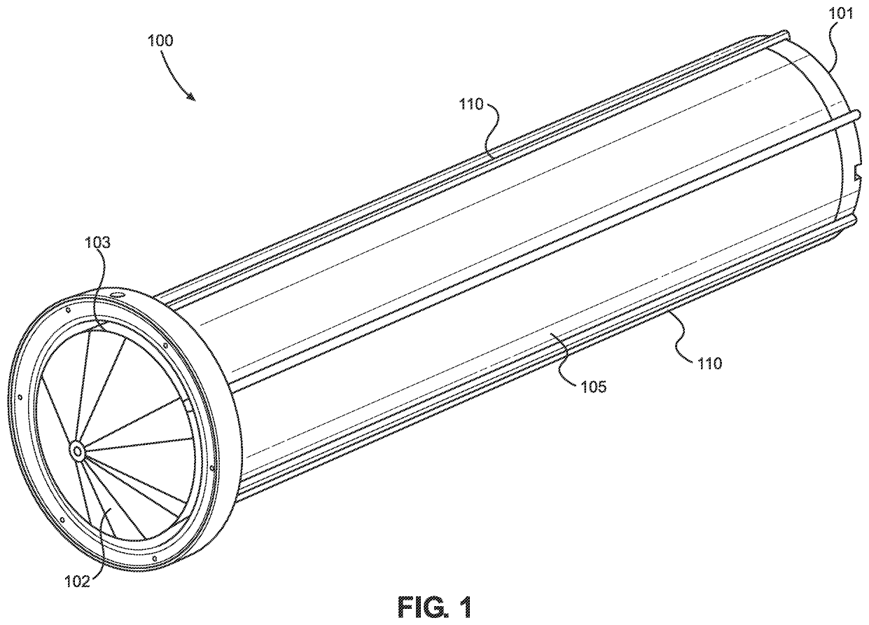

FIG. 1 illustrates an exemplary embodiment of the inner portion of the multichannel cooling system 100. The illustration does not show the jacket and tubes associated with the jacket that may surround the flow channel(s) 105. The jacket and associated tubing may or may not be present as part of cooling system 100.

The multichannel cooling system 100 has an inlet end 102 where the system may be attached to an extruder, transitionary apparatus, or interim plate, and is the end where the extrudate mixture is fed into the multichannel cooling system 100. The system 100 also has an outlet end 101 where the cooled extrudate mixture is excreted from an outlet (not shown). The inlet end contains a feeding gap or inlet 103, which is where the extrudate mixture is fed into the flow channel that is separated by divider inserts 110 into separate and multiple individual flow channels 105.

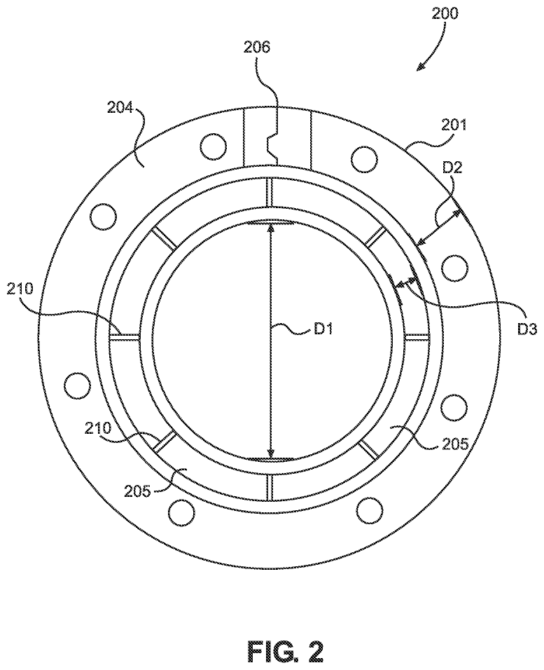

FIG. 2 is a diagrammatical representation of the frontal view of the exterior of the outlet end of one embodiment of the multichannel cooling system 200. Multichannel cooling system 200 contains an outlet end 201 comprising the jacket 204, and the flow channels 205 which are separated by divider inserts 210. The jacket may open at position 206 where both sides of the jacket come together to close around and surround the flow channels. The two sides of the jacket may be secured together with a hinge or hinge-like mechanism or even a locking chain. The extrudate material comes out of the flow channels 205 at the outlet on the outlet end (not shown) of the multichannel cooling system 200. The diameter of the inner cooling core D1 and/or the outer diameter of the jacket D2 may each be increased to allow a larger number of flow channels 205 to be placed around the inner cooling core. The height of each flow channel D3 may also be raised as the number of flow channels increase to create a thicker protein product.

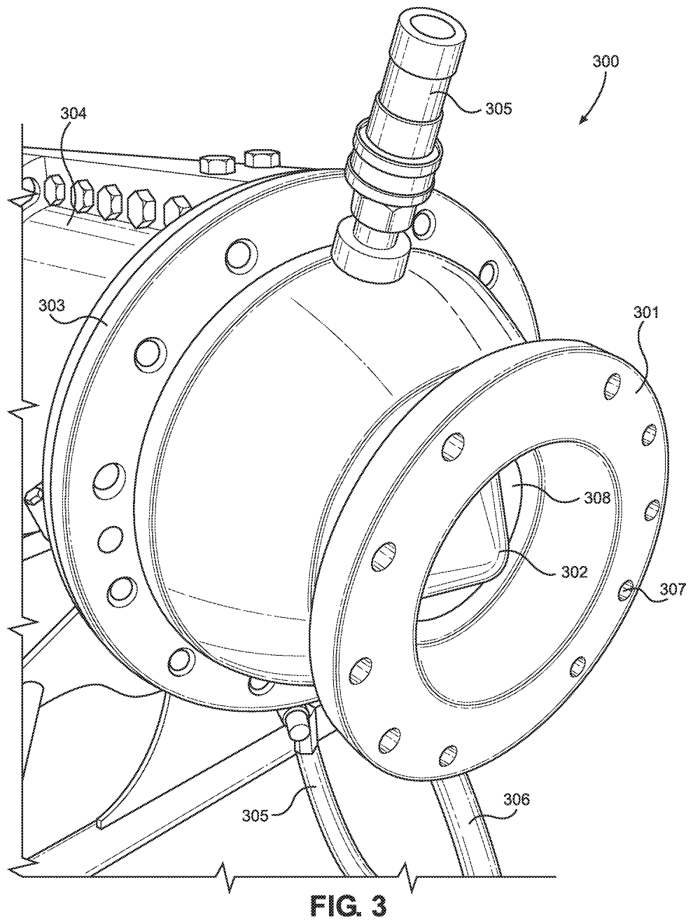

FIG. 3 presents a diagrammatical top side view of an annular cooling die 300 from the inlet end. Connection end 301 is used to couple with a transitionary apparatus such as a plate, which connects the extruder to the cooling die 300, and facilitating the movement of extrudate from the extruder to the cooling die, The transitionary apparatus or interim plate could connect to the cooling die 300 via inserts, screws or other coupling mechanisms that may go through or attach the two together through apertures 307. The inlet mid portion 302 is surrounded by the inlet 308 which in preferred embodiments is a round or circular gap. In some embodiments, the extrudate is separated into multiple flowing channels at inlet 308. Securing mechanism 303 may be opened or removed to open the cooling die 300 for cleaning or other maintenance, in this diagram it is locked into place surrounding the cooling die securing the different portions of the cooling die 300 throughout the extrusion and cooling processes. Any extrudate must travel through the cooling die body 304 as it is cooled by the cooling agents and cooling cores. Fluid inlet pipe 305 serves as an entry point of cooling agents and fluids to travel through the cooling die 300, and fluid hoses 306 allow the circulation and/or the entry and exit of cooling agents and fluids into the cooling die 300.

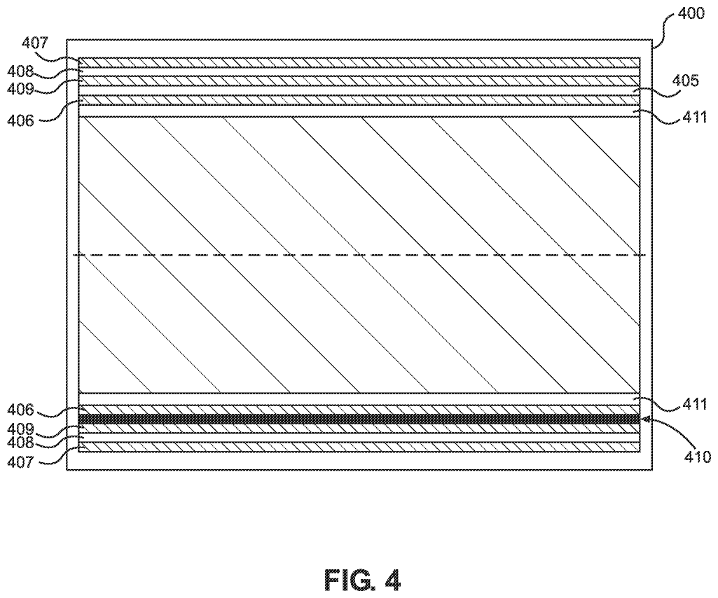

FIG. 4 is a simplified diagrammatical cross-sectional top view of one embodiment of the multichannel cooling system 400. The system 400 has several layers, at the outermost, outer tube jacket 407 serves as the outer plate or rim that surrounds cooling channel 408. Cooling channel 408 may carry cooling agent(s) and/or fluid(s) and may be placed between outer tube jacket 407 and inner tube jacket 409 and in preferred embodiments carries cooling agent(s) or fluid(s) across the length of the cooling die 400 and/or flow channel(s) 405. Inner tube jacket 409 surrounds flow channel(s) 405 which carry the extrudate mixture through the cooling die, for it to be cooled. Flow channel(s) 405 may be separated by divider inserts, 410 which in some embodiments may be inserted through the full length of the cooling die 400 and/or the length of flow channel(s) 405. The flow channel(s) 405 surround the inner cooling jacket 406, which separates the flow channel(s) 405 from the cooling core 411. Flow channel(s) 405 surround the circumference of cooling core 411, which may carry cooling agents and/or fluids throughout the center and across the length of cooling die 400 and/or flow channel(s) 405. The different segments/layers of the system 400 may be of any width length, and proportions od sizes ad diameters to each other. The exemplified embodiment is not limiting.

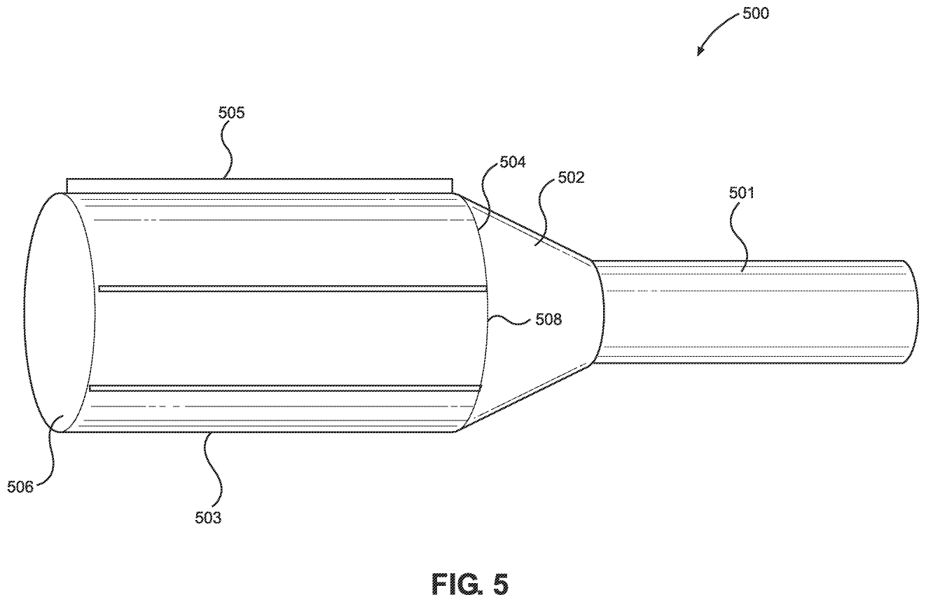

FIG. 5 is a diagrammatical representation of the core of a multichannel cooling die system 500 with full length divider inserts. The outer and inner jackets are not shown. In this embodiment, an extruder 501 from an HME process is connected to the interim plate or transitionary apparatus 502, whereby the extrudate moves from the extruder 501 through interim plate or transitionary apparatus 502 into cooling die 503. Cooling die 503 has multiple flow channels 504 created and separated by divider insert(s) 505. In preferred embodiments, the multiple flow channels 504 connect the cooling die inlet end 508 to the outlet end 506, spanning the full length of the cooling die 503. The extrudate travels through the multiple flow channels 504 towards the outlet end 506 to exit the cooling die. Divider inserts 505 span the full length of cooling die 503 and/or the full length of the multiple flow channel(s) 504, ensuring that each flow channel is completely separated from other flow channels from the inlet end to the outlet end.

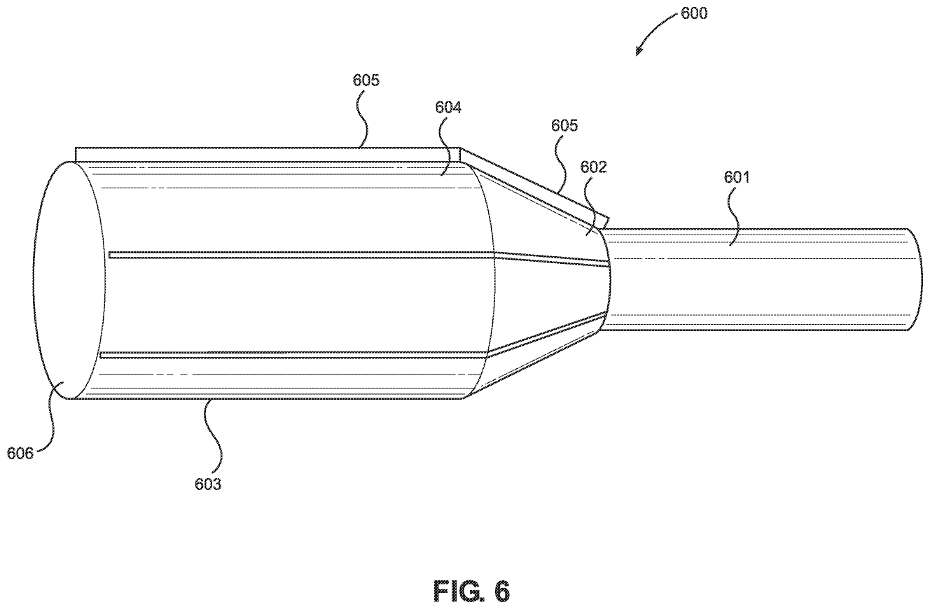

FIG. 6 is a diagrammatical representation of a multichannel cooling die 600 with extended divider inserts 605 and without showing the outer jacket. In this embodiment, an extruder 601 which may be a component of an HME process is connected to the interim plate or transitionary apparatus 602, whereby the extrudate moves from the extruder 601 through interim plate or transitionary apparatus 602 into cooling die 603. Cooling die 603 has multiple flow channels 604 created and separated by divider insert(s) 605. In this embodiment, the divider inserts 605 begin from the interim plate or transitionary apparatus 602 and extend into and throughout the full length of the cooling die 603. The divider inserts 605, and consequently the multiple flow channels 604, begin from the interim plate or transitionary apparatus 602 and extends into the cooling die 603 and throughout its length to outlet end 606, the extrudate entering the multiple flow channels at the interim plate or transitionary apparatus 602 flowing through it, into cooling die 603. Divider inserts 605 may be one piece or made up of several individual smaller pieces that connect to each other through a hinge, silicon seal, screws or bolts, or other connection or coupling mechanism(s).

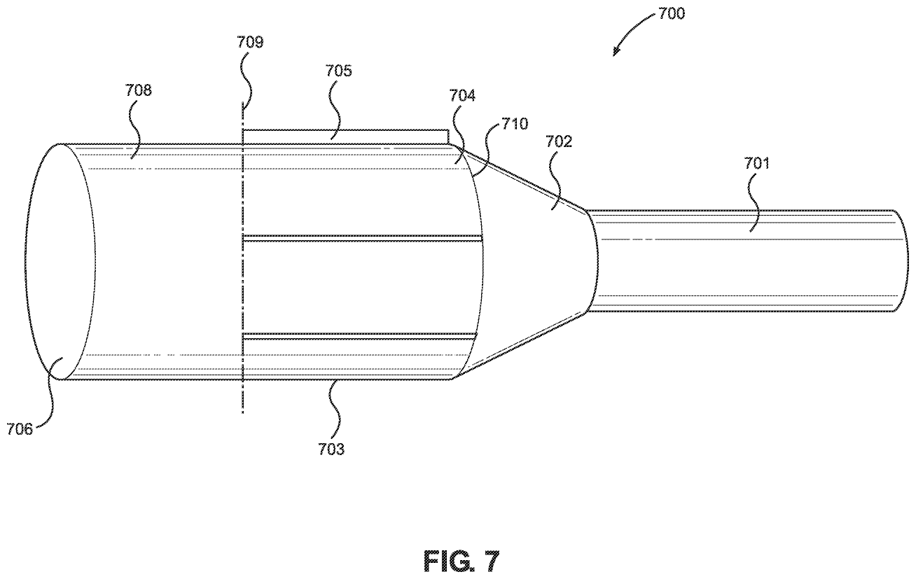

FIG. 7 is a diagrammatical representation of a multichannel cooling die (without showing the outer jacket) with shortened divider inserts 705. In this embodiment, an extruder 701 which may be a component of an HME process is connected to the interim plate or transitionary apparatus 702, whereby the extrudate moves from the extruder 701 through interim plate or transitionary apparatus 702 into cooling die 703. Cooling die 703 has multiple flow channels 704 created and separated by shortened divider insert(s) 705. The shortened divider inserts 705 extend from the inlet end 710 of the cooling die into a portion of the cooling die across its longitudinal axis, and where they stop, the multiple flow channels 704 unite together as single flow channel 708 beginning at illustrative vertical dashed line 709. The extrudate enters the multiple flow channels 704 at the interim plate or transitionary apparatus 702 flowing through it, into cooling die 703 and exiting from outlet end 706. Shortened divider inserts 705 may be one piece or made up of several individual smaller pieces that connect to each other through a hinge, silicon seal, screws or bolts, or other connection or coupling mechanism(s).

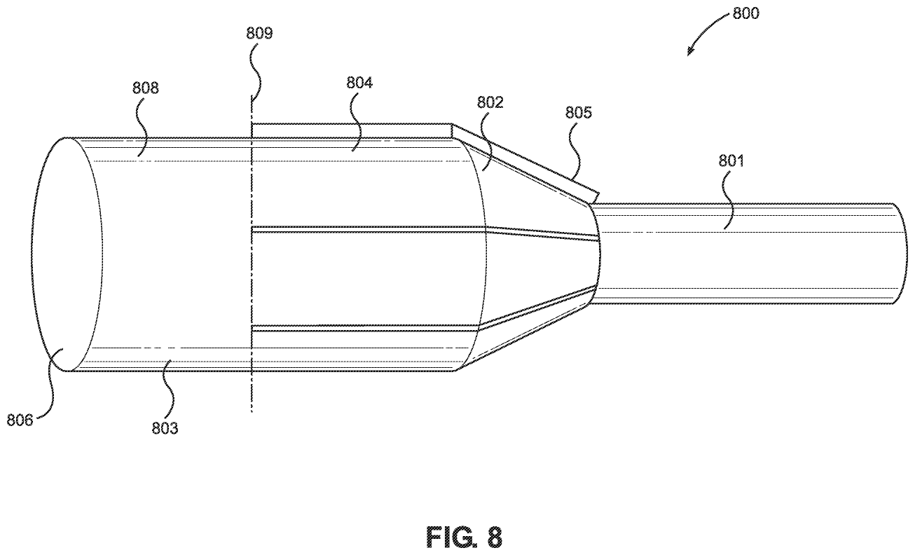

FIG. 8 is a diagrammatical representation of a multichannel cooling die (without showing the outer jacket) with custom divider inserts 805. In this embodiment, an extruder 801 which may be a component of an HME process is connected to the interim plate or transitionary apparatus 802, whereby the extrudate moves from the extruder 801 through interim plate or transitionary apparatus 802 into cooling die 803. In this embodiment, the divider inserts 805 begin from the interim plate or transitionary apparatus 802 and extend into and throughout a length of the cooling die 803. Cooling die 803 has multiple flow channels 804 created and separated by custom divider insert(s) 805. The custom divider inserts 805 extend into a portion of the cooling die across its longitudinal axis, and where they stop, the multiple flow channels 804 unite together as single flow channel 808 beginning at illustrative vertical dashed line 809. The extrudate enters the multiple flow channels 804 at the interim plate or transitionary apparatus 802 flowing through it, into cooling die 803 and exiting from outlet end 806. Shortened divider inserts 805 may be one piece or made up of several individual smaller pieces that connect to each other through a hinge, silicon seal, screws or bolts, or other connection or coupling mechanism(s).

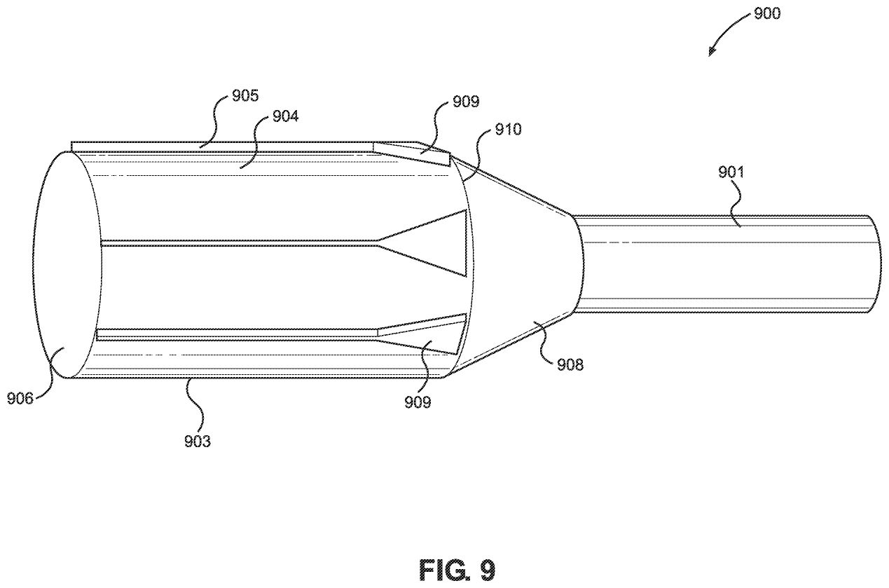

FIG. 9 is a diagrammatical representation of an accelerated flow multichannel cooling die (without showing the outer jacket) with partially widened divider inserts 905. In this embodiment, an extruder 901 which may be a component of an HME process is connected to the interim plate or transitionary apparatus 902, whereby the extrudate moves from the extruder 901 through interim plate or transitionary apparatus 902 into cooling die 903. Cooling die 903 has multiple flow channels 904 created and separated by partially widened divider inserts 905. In preferred embodiments, the multiple flow channels 904 connect the cooling die inlet end 910 to the outlet end 906, spanning the full length of the cooling die 903. The extrudate travels through the multiple flow channels 904 towards the outlet end 906 exiting the cooling die. Divider inserts 905 span the full length of cooling die 903 and/or the full length of the multiple flow channel(s) 904, ensuring that each flow channel is completely separated from other flow channels from the inlet end to the outlet end. In this embodiment, the partially widened divider inserts 905 are widened at the inlet end of the cooling die 903, and gradually narrow as they move along the longitudinal axis of the cooling die towards the outlet end 906. The widening of the portion 909 closest to the inlet end, creates a narrower passage in the multiple flow channels 904 at the inlet end 910. This narrower passage forces the extrudate through a smaller space, and as the space widens and the width of the partially widened divider inserts 905 narrow as they move along the length of the cooling die 903, the flow of the extrudate into the cooling die is accelerated and a venturi effect is created. Furthermore, the shape and width of the divider insert at the inlet end 910 can create several flow patterns in the texture of the extrudate, leading to different consistencies and fiber shapes in the extrudate to allow it to mimic different types of meat products. In this embodiment an angular shape is seen for the portion 909 at the inlet end, but round, circular, square, and other shapes can all be utilized to control the flow rate and the shape of the extrudate.

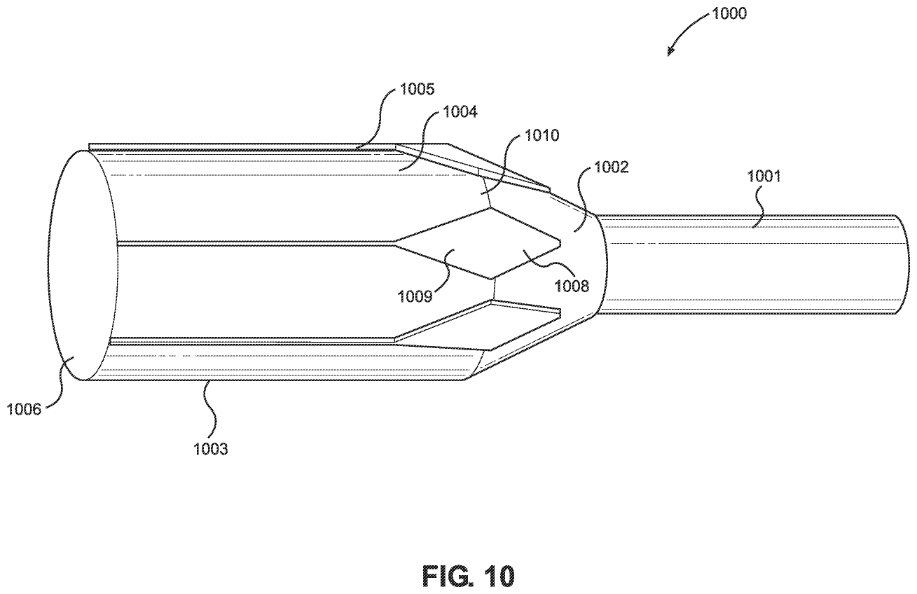

FIG. 10 is a diagrammatical representation of an accelerated flow multichannel cooling die system (without showing the outer jacket) with partially widened divider inserts 1005. In this embodiment, an extruder 1001 which may be a component of an HME process is connected to the interim plate or transitionary apparatus 1002, whereby the extrudate moves from the extruder 1001 through interim plate or transitionary apparatus 1002 into cooling die 1003. Cooling die 1003 has multiple flow channels 1004 created and separated by partially widened divider inserts 1005. In preferred embodiments, the multiple flow channels 1004 connect the cooling die inlet end 1010 to the outlet end 1006, spanning the full length of the cooling die 1003. The extrudate travels through the multiple flow channels 1004 towards the outlet end 1006 to exit the cooling die. In this embodiment, the divider inserts 1005 begin at a portion in the interim plate or transitionary apparatus 1002, in some embodiments it begins at the start of the transitionary apparatus 1002. The design presented provides for divider inserts with a widened portion 1008 in at least a portion of the transitionary apparatus 1002 and a widened portion 1009 within the cooling die 1003 close to the inlet end 1010.

In this embodiment the extrudate flows from the extruder 1001 into the transitionary apparatus 1002 and is divided by the divider inserts 1005 into different flow streams. The initial portion 1008 of each divider insert begins narrow, and in some embodiments with a pointed end, and widens as it reaches its widest point at the inlet end of the cooling die, the portion 1009 in the cooling die begins by being wide and then narrows down as it moves along the length of the cooling die 1003. The divider inserts span the full length of cooling die 1003 and/or the full length of the multiple flow channel(s) 1004, ensuring that each flow channel is completely separated from other flow channels from the inlet end to the outlet end. The narrow opening of the initial portion 1008 of the divider insert 1005 leads to a wide flow channel that progressively narrows as it reaches the portion 1009 where the flow channel 1004 begin to widen as the portion 1009 narrows into the rest of the divider insert. In this configuration the extrudate enters the flow channels 1004 through a wide flow channel, which narrows then opens to a wider passage creating an accelerated flow effect in the cooling die portion of the flow channels 1004. The flow of the extrudate into the cooling die is accelerated and a venturi effect is created. Furthermore, the shape and width of the divider insert at the portion 1008 in the transitionary apparatus 1002 can create several flow patterns in the texture of the extrudate, leading to different consistencies and fiber shapes in the extrudate allowing it to mimic different types of meat products. In this diagram a diamond opening shape is presented at the beginning of each divider insert 1005, but round, circular, square and other shapes can all be utilized to control the flow rate and the shape of the extrudate.

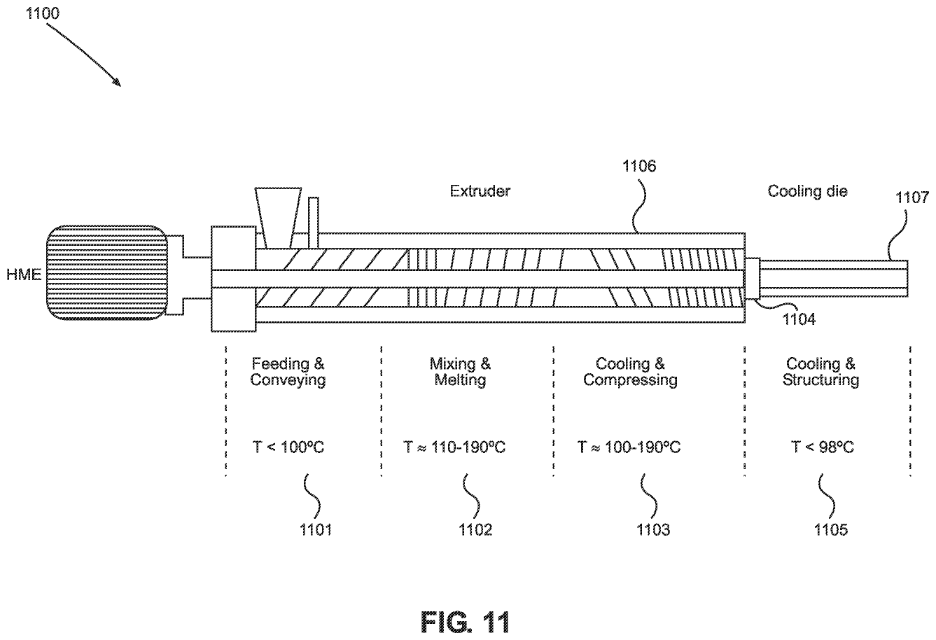

FIG. 11 is a simplified representation of the high moisture extrudate extrusion process 1100, which is comprised of feeding material and conveying it 1101 into an extruder 1106, then mixing, heating and melting the extrudate mixture at 110-190° Celsius (230-374° F.) 1102, followed by cooling and compressing the mixture in the extruder at a temperature 100-190° Celsius (230-374° F.) 1103. Finally, the extrudate material is fed into the cooling die 1107 through the transitionary apparatus or interim plate 1104 which connects the extruder and cooling die, which cools 1105 the extrudate mixture to temperature of under 98° Celsius (208° F.) and structures it. This schematic drawing is an example of one possible technical relationship/configuration between the extruder and the cooling die and does not purport to represent all other configurations, relationships or sizes of either the extruder, the cooling die or their possible configurations.

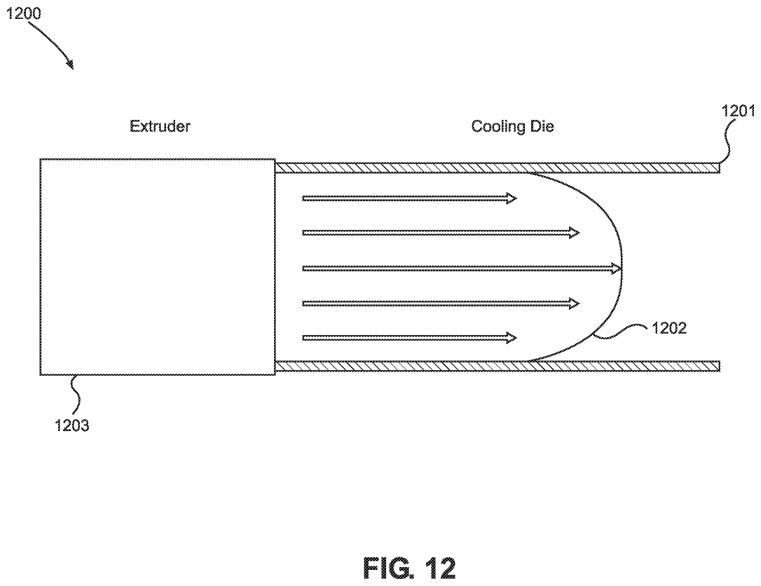

FIG. 12 is a diagrammatical representation of the process 1200 to create a laminar flow profile in the extrudate in a flat cooling die 1201. The desired laminar flow profile that most closely resembles meat-like texture is the half-moon shape. The extrudate leaves the extruder 1203 to flow through the cooling die 1201 and is pushed by the sides of the cooling die 1201 into a laminar flow shape 1202 as it moves towards an outlet of the cooling die 1201. As the extrudate cools in this flow pattern, the fibers created in the half-moon shape are solidified.

FIG. 13 shows three extrudate mixture products with different laminar flow profiles. Extrudate product 1301 has an undesirable laminar flow profile or pattern 1302. Extrudate product 1303 has an improved laminar flow profile or pattern 1304, and extrudate product 1305 has the best and most desired laminar flow profile or pattern 1306.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed.

The various embodiments described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A multichannel cooling die system, the system comprising:
a cooling die with an inlet for entry of an extrudate into the cooling die and an outlet for exit of the extrudate from the cooling die, the portion between the inlet and outlet comprising a length of the cooling die;
a cooling core that spans the length of the cooling die between the inlet and the outlet;
a flow channel that facilitates the movement of an extrudate mixture from the inlet to the outlet, spanning the length of the cooling die, adjoining and surrounding the circumference of the cooling core;
an outer jacket that spans the length of the cooling die, connected between the inlet and outlet, and circumferentially surrounding the flow channel forming an outer layer of the cooling die, the space between the inner side of the outer jacket and a base of the flow channel forming the height of the flow channel; and
one or more dividers placed in the flow channel, extending through the flow channel for a first designated length and separating the flow channel into two or more separate flow channels, wherein the one or more dividers are sealably connected to the base of the flow channel.

2. The cooling die system of claim 1, wherein the one or more dividers are sealably connected between the base of the flow channel and the inner side of the outer jacket.

3. The cooling die system of claim 1, wherein the height of the flow channel is 5-20 mm.

4. The cooling die system of claim 1, wherein the height of each of the one or more dividers is 10-11 mm.

5. The cooling die system of claim 1, wherein the outer jacket includes a cooling fluid channel.

6. The cooling die system of claim 1, wherein the one or more dividers are inserts that may be selectively removed.

7. The cooling die system of claim 1, wherein the one or more dividers are each made up of at least three separate pieces sealably conjoined, two outer pieces and one inner piece in between, together forming the width of each of the one or more dividers, wherein the two outer pieces are removable.

8. The cooling die system of claim 1, wherein the one or more dividers may each include a coolant fluid, wherein the coolant fluid is connected to a cooling system of the cooling core or the outer jacket, or both.

9. The cooling die system of claim 1, wherein the one or more dividers are made from heat resistant materials or alloys.

10. The cooling die system of claim 1, wherein the first designated length is equivalent to the length of the cooling die.

11. The cooling die system of claim 1, wherein the first designated length is equivalent to half the length of the cooling die.

12. The cooling die system of claim 1, wherein the first designated length is between one fifth to a third of the length of the cooling die.

13. The cooling die system of claim 1, wherein the first designated length is the length of the cooling die, and at least one of the one or more dividers extends through the flow channel for a second designated length.

14. The cooling die system of claim 1, wherein the width of the one or more dividers is wider at some portions than other portions.

15. The cooling die system of claim 1, wherein the width of the one or more dividers is wider at the portions closest to the inlet of the cooling apparatus than other portions.

16. The cooling die system of claim 1, further comprising a transitionary apparatus, connecting the cooling die with an extruder, to facilitate the movement of the extrudate from the extruder into each of the two or more separate flow channels.

17. The cooling die system of claim 16, wherein a portion of at least one of the one or more dividers extends into the transitionary apparatus for a third designated length.

18. The cooling die system of claim 17, wherein the third designated length is equivalent to the length of the transitionary apparatus.

19. The cooling die system of claim 17, wherein the third designated length is equivalent to the length of the transitionary apparatus, and at least one of the one or more dividers extends into the transitionary apparatus for a fourth designated length.

20. The cooling die system of claim 16, wherein the width of the one or more dividers is wider at the portions closest to the inlet of the cooling die and the outlet of the transitionary apparatus than other portions.

21. A method for cooling an extrudate in a multichannel cooling die, the method comprising:
feeding an extrudate through an inlet of a cooling die;
dividing the extrudate into separate streams via one or more divider inserts placed at the inlet end and extending through a flow channel for a first designated length, each of the one or more divider inserts dividing the flow channel into two flow channels;
moving the extrudate through one or more flow channels to an outlet of the cooling die, the base of the one or more flow channels surrounding a cooling core;
cooling the extrudate as it flows through the one or more flow channels; and
ejecting the cooled extrudate from the outlet end.

22. The method of claim 21, further comprising:
generating friction between the one or more dividers and the extrudate as the extrudate meets the one or more dividers, the friction causing the extrudate to form a half moon shape pattern in the extrudate.

23. The method of claim 21, further comprising:
accelerating the flow of the extrudate through the inlet of the cooling die by forcing the extrudate to go through a narrower flow channel opening, followed by a wider flow channel, the narrower flow channel opening caused by at least one of the one or more dividers having a wider portion close to the inlet, narrowing the flow channel for a specified length.

24. The cooling apparatus of claim 21, wherein the width of the one or more dividers is wider at some portions than other portions.

25. The method of claim 21, wherein the width of the one or more dividers is wider at the portions closest to the inlet of the cooling die than other portions.

26. A cooling apparatus comprising:
an inlet for the entry of extrudate into a cooling apparatus;
an outlet for the exit of extrudate out of the cooling apparatus; the outlet connected to the inlet via a middle portion comprising the length of the cooling apparatus;
a cooling core that spans the length of the apparatus between the inlet and the outlet;
one or more flow channels spanning the length of the apparatus to transport the extrudate from the inlet to the outlet, and adjoining at least a portion of the cooling core;
an outer jacket surrounding the one or more flow channels, and connected between the inlet and the outlet, wherein the distance between the inner portion of the outer jacket and the flow channel comprises the height of the one or more flow channels; and
one or more dividers, wherein the dividers extend in the one or more flow channels for a first designated length, each one or more divider separating two flow channels from each other for the first designated length, the one or more dividers having a height equivalent to the height of the one or more flow channels.

27. The cooling apparatus of claim 21, wherein the width of the one or more dividers is wider at some portions than other portions.

28. The cooling apparatus of claim 21, wherein the width of the one or more dividers is wider at the portions closest to the inlet of the cooling apparatus than other portions.
